(19) United States
(12) Patent Application Publication
(10) Pub. No.: US 2018/0304203 A1
(43) Pub. Date: Oct. 25, 2018

(54) CERAMIC MEMBRANE SYSTEM FOR SILICA REMOVAL AND RELATED METHODS

(71) Applicant: NANOSTONE WATER INC., Eden Prairie, MN (US)

(72) Inventors: Stanton SMITH, Eden Prairie, MN (US); Mark WAER, Eden Prairie, MN (US); Brian WISE, Eden Prairie, MN (US)

(73) Assignee: NANOSTONE WATER INC., Eden Prairie, MN (US)

(21) Appl. No.: 15/738,044

(22) PCT Filed: Jun. 17, 2016
(86) PCT No.: PCT/US2016/038201

§ 371 Date: Dec. 19, 2017

Related U.S. Application Data
(60) Provisional application No. 62/182,285, filed on Jun. 19, 2015.

(51) Int. Cl. B01D 65/02; B01D 61/14; B01D 61/16; C02F 1/44; C02F 1/52; B01D 71/02

(52) U.S. Cl. CPC B01D 65/02; C02F 2101/10; B01D 61/147; B01D 61/16; C02F 1/444; C02F 1/5236; B01D 71/02; B01D 2311/04; B01D 2315/08; B01D 2315/10; B01D 2321/162; B01D 2321/04; C02F 2303/16; B01D 2311/2642; B01D 61/145

(57) ABSTRACT

A method for removing silica includes treating feedwater with Mg at a high pH, inputting treated feedwater to an optional reactor, pumping the feedwater to a ceramic membrane in a first direction, removing precipitated solids with the ceramic membrane, and removing the precipitated solids from the ceramic membrane.

### TECHNICAL FIELD

A system for removing silica using a ceramic membrane and related methods.

### TECHNICAL BACKGROUND

Many waters contain contaminants that can present a hazard to people or the environment, or make further processing, such as evaporation or reverse osmosis more difficult. Such contaminants are often inorganic, examples include silica, hardness, heavy metal, and arsenic among others. Among these silica and hardness are problematic in that they can hamper the performance of subsequent treatment operations such as nanofiltration, reverse osmosis, and evaporation or distillation. Silica is particularly challenging to treat because it is poorly removed by ion exchange methods.

Addition of precipitating agents, coagulating agents, electrocoagulation, and pH adjustments are known as methods to convert soluble contaminants into insoluble contaminants. Once made insoluble these contaminants can be removed by known methods such as settling, or sand filtration. However these techniques often give poor removal efficiencies of the contaminants and require a large amount of space. For waters containing low amounts of contaminants, polymer membranes have been used for removal of the insoluble contaminants. Hollow fiber polymer membranes are cost effective tools to remove such precipitated contaminants but would typically be limited to operation on streams where the turbidity is less than 50 NTU. Ceramic membranes have been used to effectively treat waters having larger amounts of contaminants by the use of high cross flow velocities which continuously sweep the contaminants away during use. This cross flow significantly increases energy consumption, and abrasion due from solids flowing past the ceramic shortens membrane life leading to, a higher total system and operating cost, and decreased removal rates for contaminants of concern. These systems for removing silica from produced waters have been too limited on incoming feed water quality, been too susceptible to abrasion damage, and been too expensive to be used in other applications because of the high energy consumption and relatively short lifetimes of the ceramic membranes on these aggressively fouling waters.

What is needed is a system that overcomes these shortcomings.

### SUMMARY

A method for removing silica with a ceramic membrane water treatment system is described herein in accordance with one or more embodiments. The method includes treating feedwater with Mg at a high pH, inputting the treated feedwater into at least one ceramic membrane of a membrane module in a first direction, removing precipitated silica solids from the feedwater with the at least one ceramic membrane, and removing the precipitated solids from the ceramic membrane. The method further includes periodically regenerating the ceramic membrane with exposure to a low pH solution at a frequency from about three times per day to about once per week.

In one or more embodiments, treating feedwater at a high pH includes treating feedwater at a pH of about 9-12.5.

In one or more embodiments, treating feedwater at a high pH includes treating feedwater at a pH of about 9.5-11.5.

In one or more embodiments, treating the feedwater with Mg includes treating for 1 hour.

In one or more embodiments, the method further includes reversing feeding of the treated water and feeding the treated water through the membrane in a second direction, where the second direction is opposite the first direction.

In one or more embodiments, low pH includes a range of less than 7 pH.

In one or more embodiments, treating feedwater includes treating non-oil feedwater.

In one or more embodiments, inputting feedwater into the at least one ceramic membrane occurs exclusively in dead end mode.

In one or more embodiments, inputting feedwater into the at least one ceramic membrane occurs partially in dead end mode and a small amount of cross-feed mode.

In one or more embodiments, the method further includes inputting treated feedwater to a reactor prior to inputting the feedwater into the at least one ceramic membrane.

In one or more embodiments, the method further includes conducting a chemically enhanced backwash on the at least one ceramic membrane.

In one or more embodiments, a ceramic membrane treatment system for silica removal includes at least one feedwater input coupled with a feed line, at least one base input fluidly coupled with the feed line, the at least one base input configured to supply the feedline with Mg at a high pH. The system further includes a feed pump disposed along and fluidly coupled with the feed line, at least one membrane module having a module input, a backwash output, and a filtrate output, and the system having a first forward flow mode at a first flow rate.

In one or more embodiments, the system further includes a reactor coupled along the feedline upstream of the membrane module in the first forward flow mode.

In one or more embodiments, the system further includes a clarifier coupled with the feedline.

In one or more embodiments, the system further includes a sludge handling unit.

In one or more embodiments, wherein the high pH is a pH of about 9-12.5.

In one or more embodiments, the system has a reversed flow mode to remove insolubilized silica.

In one or more embodiments, the system further includes a low pH solution input, where the low pH solution input is in the range of less than a pH of 7.

These and other embodiments, aspects, advantages, and features of the present invention will be set forth in part in the description which follows, and will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### BRIEF DESCRIPTION OF THE FIGURES

FIG. 1 is a block diagram of a ceramic membrane system according to one or more embodiments.

FIG. 2 is a graph illustrating performance of the ceramic membrane system according to one or more embodiments.

FIG. 3 is a block diagram of a ceramic membrane system according to one or more embodiments.

### DETAILED DESCRIPTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized or structural or logical changes may be made without departing from the scope of the invention. The following detailed description is, therefore, not to be taken in a limiting sense and the scope of the invention is defined by the appended claims and their legal equivalents.

In this document, the terms “a” or “an” are used to include one or more than one, and the term “or” is used to refer to a nonexclusive “or” unless otherwise indicated. In addition, it is to be understood that the phraseology or terminology employed herein, and not otherwise defined, is for the purpose of description only and not of limitation.

A system and process for efficiently and effectively removing silica is described herein. The system includes a low pressure membrane system with chemical treatment and operating modes including dead end flow or crossflow and different backwashing modes of operation. The system can be fully automated with PLC and HMI with remote monitoring and data acquisition capability.

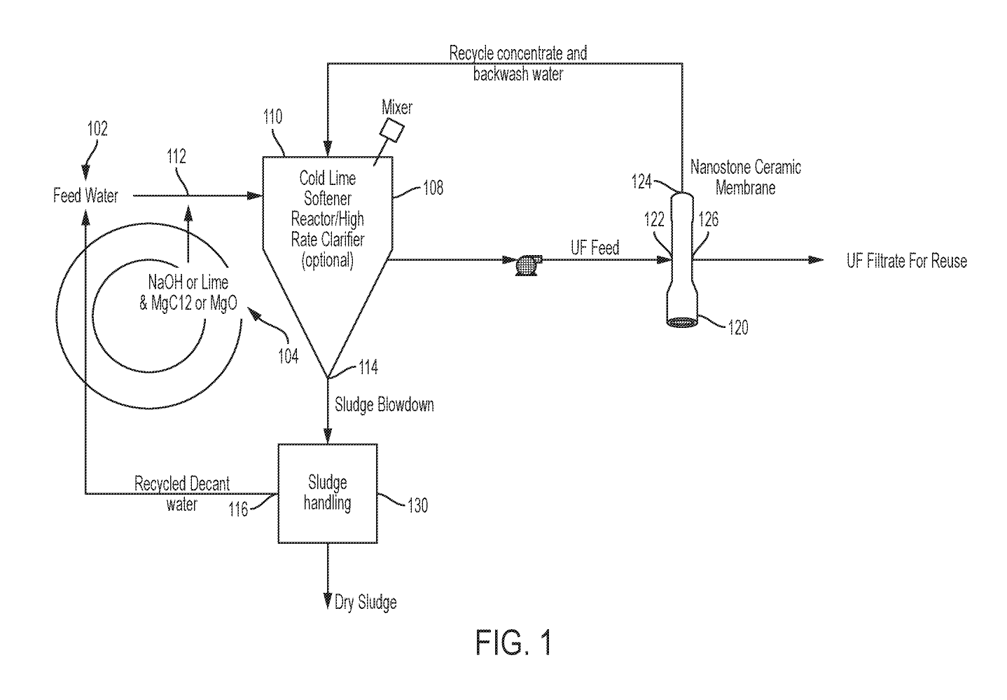

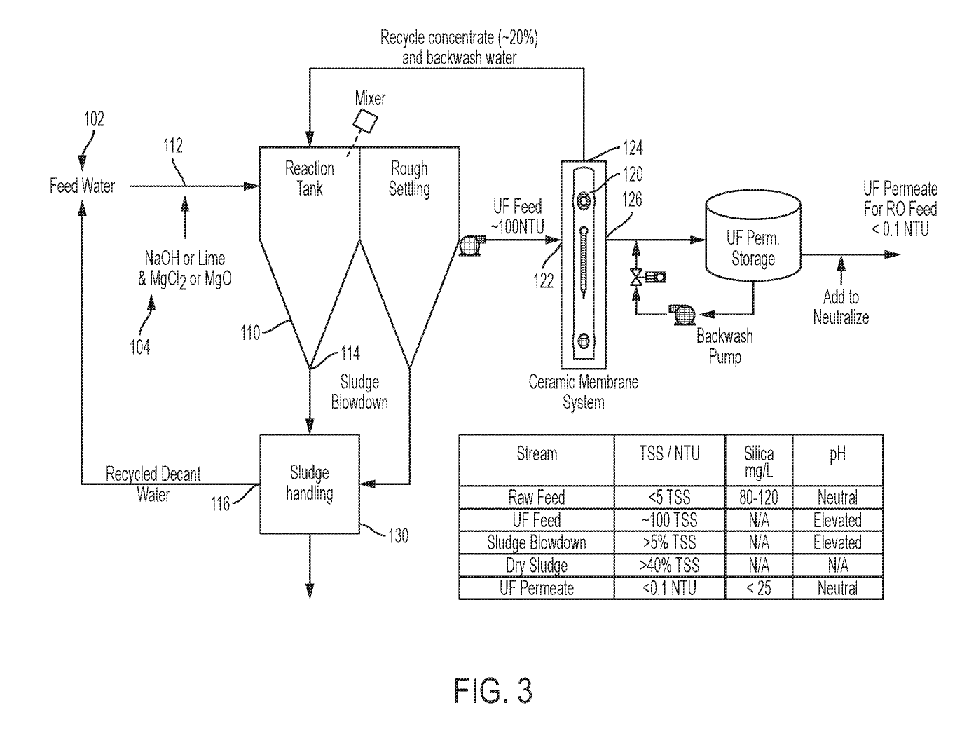

FIGS. 1 and 3 illustrate embodiments of a system 100 that includes an input of feedwater 102 to a feed line 112 and an input or inputs 104 of bases, such as NaOH, Lime, and magnesium sources such as MgCL₂, MgSO₄, or MgO, in a first direction to a reactor 110. These can be input into the feed before or after the feed pump to the ceramic membranes, or optionally to reactor 110. In one or more embodiments, Mg is dosed as a ratio to the desired silica removal and typically is in the range of 0.7 to 2 for Mg, available: Silica, removed from feed water, on a mass basis. In one or more embodiments, the Mg that is available includes added Mg and Mg that is inherent in the feed water. In one or more embodiments caustic or lime is added to raise the pH, and that depends in the pH of the feed water. For example, if the feed water already has a high pH, less caustic/lime is added. In one or more embodiments, inherent buffering of the feed water is considered, where high buffering requires high doses of caustic/lime to raise pH. In one or more embodiments, the type of Mg source is considered. For example, if MgO is used, then often less caustic/lime dose is needed.

The reactor 110 is coupled along the feedline upstream of the membrane module in the first forward flow mode. Reactor 110 can include, but is not limited to, a cold lime softener reactor. In one or more embodiments, an optional clarifier 108 can be included, which operates as a suspended solids pretreatment. In one or more embodiments, the clarifier 108 includes a hybrid clarifier, hydro cyclone, conventional filter media, or a centrifuge. In a further option, a media filter can be added after (downstream) the clarifier. The reactor 110 has an output that is fluidly coupled with a ceramic membrane 120 at a module input 122. The reactor 110 also has an output 114 to sludge handling 130. The sludge handling 130 has an output to dry sludge, and a recycled water output 116 for recycled decant water which returns to the feedwater 102. The ceramic membrane 120 has an optional backwash output 124 for recycling concentrate and backwash water to the reactor 110, and also has a filtrate output 126 for micro or ultra-filtration (UF) filtrate for reuse or further treatment. In one or more embodiments, the ceramic membrane 120 is used in dead end mode.

The system has a first forward flow mode at a first flow rate. In one or more embodiments, the ceramic membrane is used in dead end mode with a small amount of crossflow may be used.

Dead end flow is a method in which while treated water is being produced through the membrane, the feed flow rate is about equal to the treated water flow rate.

Cross flow operation is a method in which the feed flow rate is higher than the treated water flow rate, and extra feed flow exits the module after passing through the feed channels in the ceramic membrane. In one or more embodiments, a small amount of crossflow is one in which less than 5 psid of crossflow-related pressure loss is observed from the entrance to exit of the module.

In one or more embodiments, feed water, such as, but not limited to non-oil containing water, is treated with magnesium at a high pH. In one or more embodiments, a high pH is defined as 9-12.5. In one or more embodiments, a high pH is defined as 9.5-11.5. In one or more embodiments, Mg pH levels depend on temperature of the process. For example, in one or more embodiments, hotter processes can use lower pH and colder processes may use higher pH. The Mg solution itself, before being fed to the system or optional reaction tank, can range widely depending on the type of Mg and type of pre-treatment, if any, applied to the Mg. In one or more embodiments, the Mg2+ ion to be readily available when the Mg-solution hits the system or the reaction tank. The pH of the system or the reaction tank can be controlled to the high the pH ranges noted above.

In one or more options, the treated solution may optionally be allowed to remain in contact for up to one hour, and then fed to a ceramic membrane which removes a portion of the insolubilized silica. In one or more embodiments, the system includes a reversed flow mode, or the process includes occasionally reversing the flow of the separation to remove the insolubilized silica and other contaminants from the membrane surface. This may be done either with a pump running at 1 to 10 times the flow of the forward filtration, or with a pressurized reservoir running at 1 to 10 times the pressure of the forward filtration.

In one or more embodiments, the ceramic membrane is periodically exposed to a low pH solution, for example, a low pH solution prepared from treated water from the ceramic system with or without further treatment using a low pH solution input. In one or more embodiments, low pH is defined as lower than 7 and more preferably less than 5, and even more preferably 2-4. In one or more embodiments, low pH is defined as lower than operating pH, more preferably about 1 pH or more lower than the operating pH, and even more preferably about 2 or more pH units lower than the operating pH. The low pH exposure at least partially restores the ceramic membranes permeability extending its useful lifetime, and decreasing the energy intensity of the process.

Without wishing to be bound by theory, it is believed that exposure of the ceramic membrane to this pH range results in an increase in the membranes surface charge, and often a reversal of charge from negative to positive. Electrostatic interactions between the foulants and the ceramic membrane holding the foulant in place at the operational pH, decrease, or become repulsive upon exposure to this low pH exposure. As a result, this low pH exposure is believed to regenerate the ceramic membrane and restore its performance. In one or more embodiments, a measurement of regeneration is an improved permeability of the membrane before and after the regeneration event. Permeability is the production rate (flow rate) of the membrane per unit driving force (pressure).

In one or more embodiments, the method includes an optional clarification process. When a clarification process is included, the method includes treatment of 5 minutes to 2 hours. When the methods do not include a clarification process, the method includes treatment of 5 minutes-30 minutes.

In one or more embodiments, the Mg can be inherent in the feedwater, and an external source of Mg is not necessary. An agent such as caustic, NaOH and/or, Lime/Ca(OH)2 and/or MgO can be introduced to increase the pH. In another embodiment, non magnesium based insolubilizing agents could be identified to remove silica.

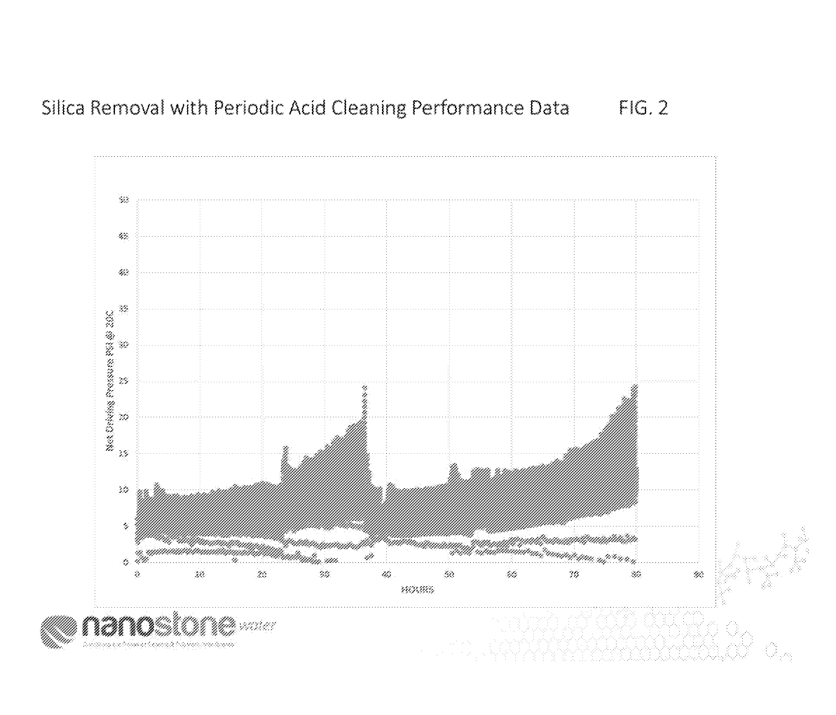

FIG. 2 illustrates silica removal with periodic acid cleaning performance data. The ceramic membrane is exposed to pH2 acid for 15 minutes, 1 time per day.

A method for removing silica with a ceramic membrane water treatment system is described herein in accordance with one or more embodiments. The method includes treating feedwater with Mg at a high pH, inputting the treated feedwater into at least one ceramic membrane of a membrane module in a first direction, removing precipitated silica solids from the feedwater with the at least one ceramic membrane, and removing the precipitated solids from the ceramic membrane. The method further includes periodically regenerating the ceramic membrane with exposure to a low pH solution at a frequency from about three times per day to about once per week.

In one or more embodiments, treating feedwater at a high pH includes treating feedwater at a pH of about 9-12.5.

In one or more embodiments, treating feedwater at a high pH includes treating feedwater at a pH of about 9.5-11.5.

In one or more embodiments, treating the feedwater with Mg includes treating for 1 hour.

In one or more embodiments, the method further includes reversing feeding of the treated water and feeding the treated water through the membrane in a second direction, where the second direction is opposite the first direction.

In one or more embodiments, low pH includes a range of less than 7 pH.

In one or more embodiments, treating feedwater includes treating non-oil feedwater.

In one or more embodiments, inputting feedwater into the at least one ceramic membrane occurs exclusively in dead end mode.

In one or more embodiments, inputting feedwater into the at least one ceramic membrane occurs partially in dead end mode and a small amount of cross-feed mode.

In one or more embodiments, the method further includes inputting treated feedwater to a reactor prior to inputting the feedwater into the at least one ceramic membrane.

In one or more embodiments, the method further includes conducting a chemically enhanced backwash on the at least one ceramic membrane.

In one or more embodiments, various methods of backwash are used for an overall operational management approach for the silica removal process.

In one or more embodiments, physical flux maintenance is used in which a backwash is applied at a set frequency (typically every 15 to 30 minutes) and period (typically 10 to 60 seconds) throughout the normal production mode. The backwash operation uses UF/MF permeate to reverse the flow direction of the production/permeate flow for a short period of time, typically less than 60 seconds, pushing permeate back through the membrane in the opposite direction of the production flow. The backwash flow rate is generated by a well-designed backwash pump and valve system that take suction from the UF permeate tank and pump the permeate through dedicated back pulse lines back to the UF membranes. Alternatively, the backwash can be produced by a compressed gas motive force using an appropriately design permeate and compressed gas vessel system and valve system which delivers the backwash flow in a similar fashion to the backwash pump and valve system. Some compressed gas systems separate the gas and liquid, e.g. air-driven piston and hydro pneumatic bladder systems, and other system may use an intermediate pressure-transmitting fluid or use a hybrid approach e.g. where a liquid pump is used to generate the gas compression rather than direct gas-side compression. Backwash serves to physically remove or lift materials from the membrane surface, after which production resumes with improved efficiency. Backwash can improve overall productivity of a membrane plant and can reduce the need for chemical cleaning and associated down time.

In one or more embodiments, a feed flush is applied at a set frequency which is similar to that of backwash and can be performed in concert and/or alternate with backwash (typically every 15 to 30 minutes) throughout the normal production mode. Feed flush uses feed to flush the membrane surface, rather than treat the feed to produce concentrate and permeate, with a goal to remove contaminants from the membrane surface. The feed flush enters at one end of the membrane and flushes across the entire length of the membrane surface, removing contaminants from the entire length of the membrane, and then contaminants are removed with the feed flush stream at the opposite end of the membrane. Feed flush could also be applied from different feed-side ends of the membrane to address local accumulations of contaminants and this is especially useful when particles accumulate on the membrane inlet areas, in that it can re-suspend such particles, preventing cake build up and possible membrane plugging risk. In the extreme case, continuous feed circulation could be considered rather than intermittent feed flush, but energy cost as well as capital impact on the membrane system need to be carefully considered in such cases and pre-treatment of the feed for contaminant reduction or modification may be a potentially preferred approach.

In one or more embodiments, a chemical flux maintenance is utilized. Backwash and feed flush are physical cleaning methods, and some foulants may have adsorptive or electrostatic interaction with the membrane, and these foulants may elude the cleaning impact of backwash and feed flush. Such foulants will need chemical flux maintenance in order to be removed from the membrane. This typically includes either chemically enhanced backwash or maintenance clean-in-place (mCIP), a combination of these two steps, or modifications of these two approaches. Chemical flux maintenance is typically implemented at a set frequency, but can also be triggered by acute unplanned events, such as feed upsets or unusual above-design production need, leading to increased fouling rates. Chemical flux maintenance typically is completed in under one hour, and is typically applied with a frequency ranging from twice per day to twice per calendar week. Since chemical flux maintenance requires substantially more time per event than physical flux maintenance and additionally uses chemicals to achieve cleaning therefore producing potential spent chemical wastes rather than using simple feed and or permeate, it is typically less preferred to physical flux maintenance (backwash and feed flush). However, is often an unavoidable reality due to the previously described fouling nature of most commercial MF/UF feed streams.

The two typical chemical flux maintenance methods are briefly described below. In one or more embodiments, the chemically enhanced backwash uses either the permeate or an external high quality water source, adds appropriate chemicals and/or heat to the source water and drives it backward through the membrane in a reverse direction to production. In one or more embodiments, the chemically enhanced backwash is typically of pH <8 and often is a mineral acid such as HCl, HNO3 or a mix of acids/buffers placed into the ceramic ultrafiltration (CUF) permeate itself, to reduce the pH of the permeate from >pH 9 to <pH 8. In one or more embodiments, chemically enhanced backwash can be performed by an external/non-CUF permeate fluid of desired pH <8 and with appropriate quality.

The chemically-dosed fluid displaces all residual permeate and feed in contact with the membrane which can either be drained or not drained prior to the displacement event. Once displacement is complete, the membrane is soaked in the chemically-dosed fluid, which may be refreshed if needed batch-wise or continuously. Once soaking is complete, the chemical may be drained or simply displaced or flushed with feed, and production is resumed with improved efficiency. Follow-on chemical or physical flux maintenance steps can be implemented prior to resuming production.

In one or more embodiments, maintenance clean-in-place (mCIP), unlike chemical backwash, typically uses either raw feed, UF/MF permeate or less-commonly an external high quality source water, adds chemical to it, and circulates the water from the feed side of the membrane either or both across the membrane surface (not unlike a circulating feed flush) and through the membrane (not unlike production). The chemically dosed water leaving the membrane is typically circulated back to the feed side of the membrane in a closed loop arrangement, with optional refreshment of the cleaning solution. A soak step can be implemented as part of the maintenance CIP. After maintenance CIP is completed, the spent wash solution is typically drained, but could also be displaced by a rinse solution or feed. Once maintenance CIP is complete, production is resumed with improved efficiency. Follow-on chemical or physical flux maintenance steps can be implemented prior to resuming production.

In one or more embodiments, the methods include Recovery Clean-in-Place (rCIP or CIP). Chemical flux maintenance adds a second layer of flux maintenance over backwash and feed flush that reduces, but these do not completely eliminate residual fouling. To completely restore the membranes and remove all residual foulants, a recovery clean-in-place (CIP) is performed using typically more concentrated cleaning chemical formulations at elevated temperatures with a longer contact time with the membranes. As with all the cleaning operations, the CIP is performed inside the UF/MF skid, but in the case of CIP, the skid is typically taken offline, drained, rinsed, and then fed a cleaning solution. This cleaning solution is contacted with the membrane for an extended period, usually longer than one hour. This process is typically repeated with similar or different chemical formulations, after a rinse step, and then the membrane performance is benchmarked for restoration efficiency before going back on line. Additional CIP chemical steps can be implemented based on the bench mark membrane performance, until the membrane is fully restored to the desired benchmark level. This process typically requires 2 to 12 hours to be completed, and as such represents a significant amount of time for a portion of the membrane plant to spend outside of its regular production function, hence clearly being a last resort cleaning tool for managing a membrane plant. Various parameters impact the CIP frequency such as feed type, membrane removal efficiency, physical and chemical maintenance cleaning efficiency, and frequency of feed upsets, amongst other, but typically a period of one week to one year may be expected for CIP frequency.

In one or more embodiments, a chemically enhanced backwash method of chemical flux maintenance is employed optionally along with backwash and feed flush, and ultimately chemical clean in place (CIP), as the overall operational management approach for the silica removal process.

In one or more embodiments, the chemically enhanced backwash includes the following steps. In one or more embodiments, a chemical solution is prepared in a dedicated chemically enhanced backwash tank filled with chemically enhanced backwash water and blended with a chemical of choice for the chemically enhanced backwash and adjusted to the desired conditions for chemically enhanced backwash inside the chemically enhanced backwash tank. Alternatively, in one or more embodiments, a chemical is selected and the chemical supply pump readied to transfer the selected pure chemical directly into the flowing chemically enhanced backwash water source during the chemically enhanced backwash water transfer step from the chemically enhanced backwash source water tank to the membrane skid. In one or more embodiments, the chemically enhanced backwash water source may be UF permeate or an external water source.

In one or more embodiments, during execution of the chemically enhanced backwash, production is stopped, typically physical flux maintenance is applied, either standard or modified routines of pFM can be used. The system may be drained if desired.

In one or more embodiments, the chemically enhanced backwash solution, either pre-blended or in-line blended is transferred to the membrane skid and contacted with the membranes from the permeate side of the membrane. The solution is pumped through the membranes and can continually flow or can be soaked in the membranes without flow or a combination of flow and soak. The chemically enhanced backwash solution transfer rate and the soak time with the membranes, if any, as well as the total solution volume transfer can be adjusted for efficiency based on experience.

After backwash occurs, production or forward flushing is restarted. Upon completion of the chemically enhanced backwash execution step, the chemically enhanced backwash transfer is stopped if still active, and no fresh chemically enhanced backwash chemical is supplied to the membrane skid from this point onward. The system may be drained at this point, but could also be flushed with either chemical free chemically enhanced backwash source water, any external water source or UF permeate. Typically, physical flux maintenance is applied, and either standard or modified routines of pFM can be used. Any additional chemical chemically enhanced backwash steps with different or similar chemicals could be applied at this point, and the outlined procedure repeated. Final verification of the readiness to restart may be performed, and then regular production can resume, ideally with improved efficiency.

A complete chemically enhanced backwash typically takes each membrane skid off-line for about 20 to 30 minutes at a set frequency, ranging from three times each day to once per month or more. The chemically enhanced backwash source water may be heated, adjusted in salinity, buffering capacity, and other such pre-conditioning steps. The efficiency of the chemically enhanced backwash is usually measured either by doing a clean water permeability check, or by tracking the product permeability before and after a chemically enhanced backwash event with higher permeability post-chemically enhanced backwash implying successful chemically enhanced backwash event.

The methods provide for a low energy treatment process for reliably treating silica containing waters over long periods of times. Existing solutions have led to the ceramic membrane having a relatively short lifetime due to the non-recoverable loss of flux driven by fouling. Cross flow has been used to mitigate this loss, but that has been insufficient to extend lifetimes and has increased the energy required to process the feed water. These challenges have limited the applicability of this process for removing silica to applications where short lifetimes are acceptable. By identifying the specific operating steps to maintain permeability over long periods of time, this process allows silica to be removed in a wide range of waters.

RO systems typically waste an amount of the water as concentrate. The specific amount of water that needs to be wasted is very frequently set by the amount of silica in the feedwater due to its formation of insoluble species when its concentration reaches ˜100 ppm in typical water conditions. With appropriate anti-scalants this can be extended to about 300 ppm, but it is still the limiting factor in the amount of waste an RO system will generate. There aren't commercially viable methods available to reliably remove silica outside of chemical insolubilization. This method allows widespread increases to RO system recovery (reducing wasted waters) in places where a commercially viable method was not previously used, where less water is wasted.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings can be combined to form additional embodiments of the present application. The scope should, therefore, be determined with reference to the appended claims, along with the full scope of equivalents to which such claims are entitled.

1. A method for removing silica with a ceramic membrane water treatment system, the method comprising:
treating feedwater with Mg at a high pH;
inputting the treated feedwater into at least one ceramic membrane of a membrane module in a first direction;
removing precipitated silica solids from the feedwater with the at least one ceramic membrane;
removing the precipitated solids from the ceramic membrane; and
periodically regenerating the ceramic membrane with exposure to a low pH solution at a frequency from about three times per day to about once per week.

2. The method as recited in claim 1, wherein treating feedwater at a high pH includes treating feedwater at a pH of about 9-12.5.

3. The method as recited in claim 1, wherein treating feedwater at a high pH includes treating feedwater at a pH of about 9.5-11.5.

4. The method as recited in any one of claims 1-3, wherein treating the feedwater with Mg includes treating for 1 hour.

5. The method as recited in claim 1, further comprising reversing feeding of the treated water and feeding the treated water through the membrane in a second direction, where the second direction is opposite the first direction.

6. The method as recited in claim 1, wherein low pH includes a range of less than 7 pH.

7. The method as recited in claim 1, wherein treating feedwater includes treating non-oil feedwater.

8. The method as recited in claim 1, wherein inputting feedwater into the at least one ceramic membrane occurs exclusively in dead end mode.

9. The method as recited in claim 1, wherein inputting feedwater into the at least one ceramic membrane occurs partially in dead end mode and a small amount of cross-feed mode.

10. The method as recited in claim 1, further comprising inputting treated feedwater to a reactor prior to inputting the feedwater into the at least one ceramic membrane.

11. The method as recited in any one of claims 1-10, further comprising conducting a chemically enhanced backwash on the at least one ceramic membrane.

12. A ceramic membrane treatment system for silica removal, the system comprising:
at least one feedwater input coupled with a feed line;
at least one base input fluidly coupled with the feed line, the at least one base input configured to supply the feedline with Mg at a high pH;
a feed pump disposed along and fluidly coupled with the feed line;
at least one membrane module having a module input, a backwash output, and a filtrate output; and
the system having a first forward flow mode at a first flow rate.

13. The ceramic membrane treatment system for silica removal as recited in claim 12, further comprising a reactor coupled along the feedline upstream of the membrane module in the first forward flow mode.

14. The ceramic membrane treatment system for silica removal as recited in claim 12, further comprising a clarifier coupled with the feedline.

15. The ceramic membrane treatment system for silica removal as recited in claim 12, further comprising a sludge handling unit.

16. The ceramic membrane treatment system for silica removal as recited in claim 12, wherein the high pH is a pH of about 9-12.5.

17. The ceramic membrane treatment system for silica removal as recited in any one of claims 12-16, wherein the system has a reversed flow mode to remove insolubilized silica.

18. The ceramic membrane treatment system for silica removal as recited in any one of claims 12-17, further comprising a low pH solution input.

19. The ceramic membrane treatment system for silica removal as recited in claim 18, wherein the low pH solution input is in the range of less than a pH of 7.
